(19) United States
(12) Patent Application Publication
(10) Pub. No.: US 2001/0003173 A1
(43) Pub. Date: Jun. 7, 2001

(54) Method for increasing recognition rate in voice recognition system

(75) Inventor: Keun Ok Lim, Kyounggi-do (KR)

Correspondence Address: FLESHNER & KIM, LLP, P. O. Box 221200, Chantilly, VA, 20153-1200, US

(73) Assignee: LG Electronics Inc.

(21) Appl. No.: 09/729,768

(22) Filed: Dec. 6, 2000

(30) Foreign Application Priority Data
Dec. 7, 1999 (KR) 55509/1999

(51) Int. Cl. G10L 15/08; G10L 15/00; G10L 15/12

(52) U.S. Cl. 704/239

(57) ABSTRACT

A method for increasing voice recognition rate in a voice recognition system comprising the steps of: establishing a reference model for user voices subjected to recognition; receiving the user voices for voice recognition commands; detecting the range and characteristics of the received voice data; comparing the range and characteristics of the detected voice data with the characteristics of the previously obtained reference voice model to retrieve a word having the largest similarity; comparing the similarity of the retrieved word with the similarity reference value to report a voice recognition failure when the compared result is below the reference value, and to report a voice recognition success and perform the command corresponding to the recognized word when the compared result is at least the reference value; and modifying the characteristics of the voice data which succeeded in the voice recognition into the reference voice model which was used in the corresponding voice recognition. According to the method, the reference model is modified by the characteristics of the voice data entered by the user and succeeded in the voice recognition so that the more accurate reference voice model can be more effectively established.

### BACKGROUND OF THE INVENTION

1. Field of the Invention

The invention relates to a voice recognition system, and in particular to a method for increasing recognition rate in a voice recognition system in which voice data of a user is reflected to a previously registered reference voice model so that voice recognition rate can be increased in recognizing voices entered from the user.

2. Description of the Related Art

A voice recognition system is one of input means of electronic articles which recognizes voices entered from a user and performs operations in accordance with recognized commands. For such a voice recognition, the system has two major functions, i.e., “training” and “recognition”.

Herein, “training” is a process for obtaining a reference voice model about the voices of the user in which the voices of the user are entered in several times so that characteristics of the entered voices are extracted to form voice data for the reference model of the user voice, and “recognition” means a process for comparing the voice data of the reference voice model with a voice entered from the user to discriminate the entered voice. In other words, the voice recognition system discriminates the entered voice by the trained reference voice model, in which the process of training the reference voice model can obtain more reference voice model as the training process is repeated.

FIG. 1 is a flow chart for showing a method for recognizing voice in a voice recognition system of the prior art.

Referring to FIG. 1, the voice recognition system is repeatedly entered with voices subjected to recognition from a user to establish a reference voice model of specific command languages.

After the reference voice model is established, when a user voice is entered for a specific command to an electronic article (Step 101), the voice recognition system detects the voice range entered from the user to extract the characteristics of the voice (Step 102).

Here, judgment is carried out whether the voice range and the characteristics are successfully detected (Step 103), when voice data are successfully detected as a result of the judging step, the reference voice model is retrieved for a word having the largest similarity to the detected voice data (Step 104). The recognized voice and the retrieved word are compared to obtain similarity there between (Step 105), when the similarity is proved at least reference value as a result of the comparison, a message is reported to the user that the voice recognition succeeded and the voice recognition process for performing a corresponding command is completed.

Here, when the step 103 failed to detect the voice range from the entered voice, a message is displayed to report that the voice range detection is failed (Step 103a), and when the compared similarity value of the recognized voice and the retrieved word is below the reference value in the step 105, a message is displayed to report that there are no registered words (Step 105a).

The foregoing voice recognition system of the prior art discriminates the entered voices by the previously established reference voice model. Therefore, when the reference voice model is erroneously established due to noise, incorrect pronunciation of the user or etc. in establishing the reference model, the voice recognition rate may degrade. Also, repeating the voice training is required for accurate establishment of the reference voice model so that the voices should be repeatedly entered by the user thereby causing the user troublesome.

### SUMMARY OF THE INVENTION

It is therefore an object of the invention, which is proposed to solve the foregoing problems, to provide a method in which voice characteristics are extracted from voice data entered by a user for voice recognition and compared to an established reference voice model, and then, when the voice recognition succeeded, corresponding commands are performed and the voice data are reflected to the previously established reference voice model so that effect of repeating training on the user voices can be expected thereby increasing the voice recognition rate.

According to the object of the invention, it is provided a method for increasing voice recognition rate in a voice recognition system comprising the steps of: establishing a reference model for user voices subjected to recognition; receiving the user voices for voice recognition commands; detecting the range and characteristics of the received voice data; comparing the range and characteristics of the detected voice data with the characteristics of the previously obtained reference voice model to retrieve a word having the largest similarity; comparing the similarity of the retrieved word with the similarity reference value to report a voice recognition failure when the compared result is below the reference value, and to report a voice recognition success and perform the command corresponding to the recognized word when the compared result is at least the reference value; and modifying the characteristics of the voice data which succeeded in the voice recognition into the reference voice model which was used in the corresponding voice recognition.

Preferably, the characteristics of the voice data succeeded in the voice recognition via comparison with the previous reference voice model are used to modify the reference voice model.

Preferably, the voice recognition rate increases in accordance with the number of the voice entering of the user on the specific commands and success in the voice recognition.

Preferably, the characteristics of the voice data are expressed in characteristic vectors which are applied with entering patterns including LPC(Linear Predictive Coding) coefficient, cepstrum and differential cepstrum coefficient and etc.

Further preferably, the voice date succeeded in the voice recognition are reflected to the reference voice model so that training and recognition processes are further included for establishing the reference voice model.

### BRIEF DESCRIPTION OF THE DRAWINGS

FIG. 1 is a flow chart for showing a method for recognizing voice in a voice recognition system of the prior art; and

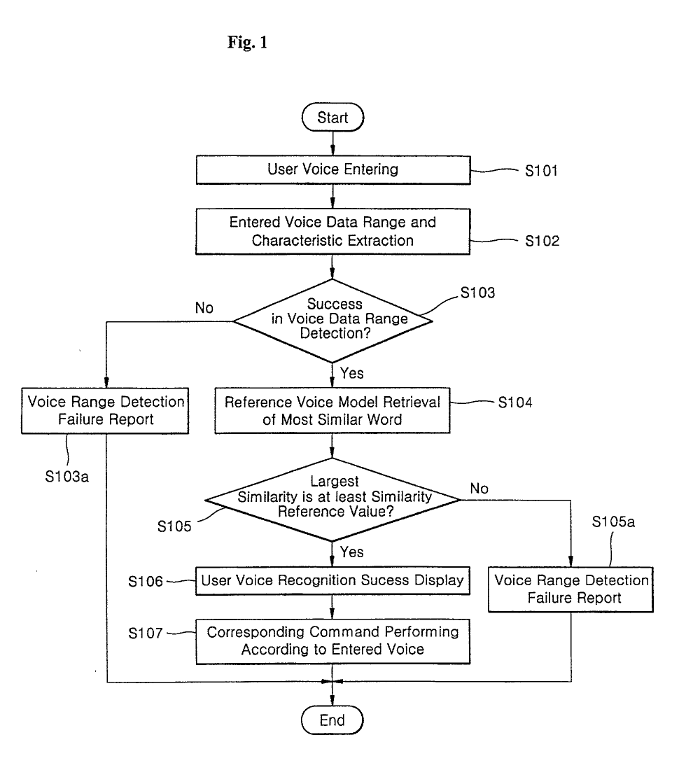

FIG. 2 is a schematic structural view of a voice recognition system applied to a mobile communication terminal according to an embodiment of the invention; and

FIG. 3 is a flow chart for showing a method for recognizing voice in a voice recognition system according to the invention.

### DETAILED DESCRIPTION OF THE PREFERRED EMBODIMENT

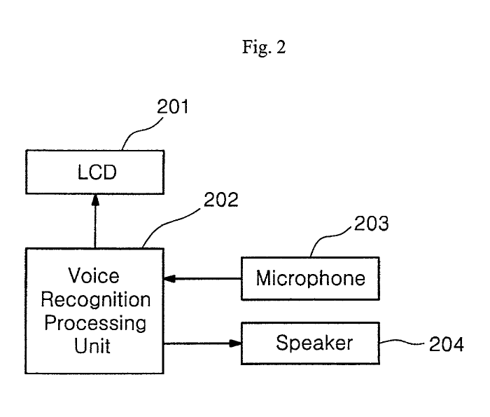

A voice recognition system of a mobile communication system according to an embodiment of the invention is described as follows in reference to FIG. 2.

Referring to FIG. 2, the voice recognition system is comprised of a microphone 201 for receiving voice signals for recognition of user voices, a speaker 202 for outputting success or failure of the voice recognition, an LCD 203 for displaying the success or failure of the voice recognition, and a voice recognition processing unit 204 having a reference voice model of the user for determining similarity of a voice recognition command of the user to the reference voice model to perform the voice recognition command or not, and for updating the voice reference model with the voice recognized data.

This voice recognition system applied to the mobile communication terminal is briefly described as follows:

First, when the user proceeds into a mode pertinent for establishing the reference voice model, the user voice is inputted via the microphone 201 after recognized in the voice recognition processing unit 204. The voice signal is encoded in the voice recognition processing unit 204.

Then, the voice recognition processing unit 204, after repeatedly inputted with a specific voice range, obtains reference voice models of the voice data via the range and feature of the voice data and stores each of the reference voice models into a memory (not shown).

In a voice recognition mode after the reference voice models are obtained, the voice recognition command of the user inputted via the microphone is transmitted to the voice recognition processing unit 204. The voice recognition processing unit 204 detects data range and feature of the voice recognition command. The successfully detected range and feature are compared with the reference voice model stored in the memory so that the reference voice model having the largest similarity can be obtained.

Here, the voice recognition processing unit 204 notifies about success or failure of detecting the data range and feature of the voice recognition command and failure of voice recognition via the speaker 202 or LCD 203.

When the voice command data are successfully recognized, operations corresponding to the voice command data including speech, dialing, internet connection, speech off and etc. are performed so that a function such as pushing a key pad for example is performed by using the user voice which is recognized by the voice recognition system.

Here, when the current voice command data succeeded in the voice recognition has similarity value larger than that of the reference voice models, the voice recognition processing unit 204 compares if the similarity value is at least the established reference value and updates the corresponding reference voice model stored in the memory with the voice command data when the similarity value is at least the established reference value.

In other words, when the current user voice recognition command is at least the similarity value, the reference voice model, which was the reference of the current voice recognition command, is erased and the current voice recognition command is stored as the reference voice model.

In this manner, the voice recognition training can be performed together with the voice recognition command at the same time for recognizing the user voice so that a better voice reference model can be stored into the memory.

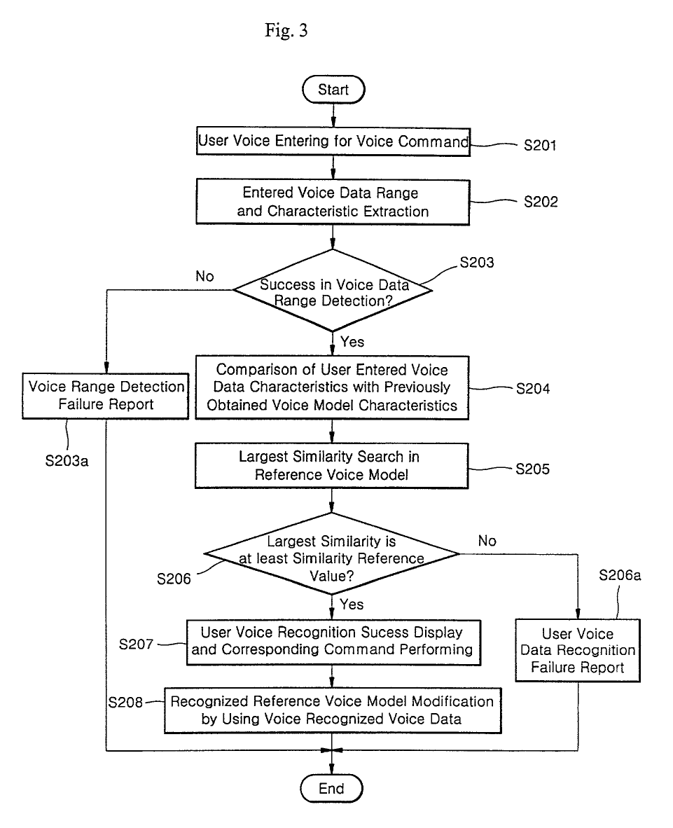

Meanwhile, a method for increasing voice recognition rate in a voice recognition system according to the invention will be described in detail in reference to FIG. 3.

First, the voice recognition system is repeatedly entered with voices subjected to recognition from a user to establish a reference voice model. Here, the voice entering is carried out about twice for the sake of convenience of the user.

After the reference voice model is established, when a user voice corresponding to a specific command is entered for the command (Step 201), the voice recognition system extracts the range and characteristics of the voice data of the user (Step 202).

Here, judgment is carried out to find whether the range and characteristics of the voice data are successfully detected or not (Step 203), and when the voice data are successfully detected as a result of the judgment, the characteristics of the voice data are compared to the characteristics of the previously reflected reference voice model (Step 204), and a word having the largest similarity is recognized (Step 205). Here, when the voice range is not detected from the entered voice in step 203, a message is displayed to report that the detection of the voice range failed (Step 203a).

Here, characteristic vectors which express the characteristics of the voice data are applied with entering patterns including LPC(Linear Predictive Coding) coefficient, cepstrum, differential cepstrum coefficient and etc.

After the largest similarity is obtained from the recognized word, the similarity is compared to the similarity reference value (Step 206).

When the similarity is at least the reference value as a result of the comparison in the step 206, a recognition success message is displayed and a command corresponding to the currently recognized word is performed (Step 207). When the similarity is below the reference value, a message is displayed to the user to report that the recognition failed due to nonexistence of registered words or incorrect pronunciation and a voice reentering step or end step is carried out (Step 206a).

Here, in the word having a similarity at least the reference value in the step 205, since the system recognized the current voice of the user, the voice data are reflected to modify the reference voice model so as to treat the voice as one training process (Step 207).

The reference voice model reflected in the step 207 are compared to the voice data entered by the user as above, and then the word having the largest similarity is recognized.

Accordingly, when it succeeded in recognizing user voices entered for voice recognition, the reference model is modified by the characteristics of the voice data so that the voice data about specific command languages having high use frequency are reflected with relatively correct reference voice model in modification thereby ensuring relatively high recognition rate of the voice data and many voice data are used to obtain the reference word model thereby ensuring high voice recognition rate of the voice recognition system.

Therefore, according to the invention, the voice data characteristics recognized through comparison with the voices of the reference voice model established in the voice recognition system are reflected in establishing the reference voice model. So, as the voice recognition of the specific commands is repeated, effect of training voice recognition can be expected thereby establishing an accurate reference voice model.

Also, the characteristics of relatively correct voices are applied to the establishment of the reference voice model used in recognizing the voice except the characteristics of relatively incorrect voices so that the accurate reference voice model can be more effectively established As described hereinabove, the method for increasing voice recognition rate in the voice recognition system uses the voice-recognized voice to establish the reference voice model used for recognizing the voice thereby having an effect of repeating the voice recognition training so that the voice recognition rate can be increased without repeating training a number of times. Furthermore, only the characteristics of the voice having relatively high similarity are applied in establishing the reference voice model so that accurate reference voice model can be more effectively established.

What is claimed is:

1. A method for increasing voice recognition rate in a voice recognition system comprising the steps of:
establishing a reference model for user voices subjected to recognition;
receiving the user voices for voice recognition commands;
detecting the range and characteristics of the received voice data;
comparing the range and characteristics of the detected voice data with the characteristics of the previously obtained reference voice model to retrieve a word having the largest similarity;
comparing the similarity of the retrieved word with the similarity reference value to report a voice recognition failure when the compared result is below the reference value, and to report a voice recognition success and perform the command corresponding to the recognized word when the compared result is at least the reference value; and
modifying the characteristics of the voice data which succeeded in the voice recognition into the reference voice model which was used in the corresponding voice recognition.

2. The method for increasing voice recognition rate in a voice recognition system in accordance with claim 1, wherein the characteristics of the voice data are expressed in characteristic vectors which are applied with entering patterns including LPC(Linear Predictive Coding) coefficient, cepstrum and differential cepstrum coefficient and etc.

3. A method for increasing voice recognition rate in a voice recognition system comprising the steps of:
detecting the characteristics of voice data received from a user;
comparing the detected characteristics with a previously established reference voice model to judge success or failure of the voice detection; and
establishing each of the voice data succeeded in the voice detection to the reference voice model of the corresponding voice.
